(19) United States
(12) Patent Application Publication
(10) Pub. No.: US 2025/0054150 A1
(43) Pub. Date: Feb. 13, 2025

(54) MEDICAL IMAGE PROCESSING APPARATUS AND MEDICAL IMAGE PROCESSING METHOD

(71) Applicant: CANON MEDICAL SYSTEMS CORPORATION, Otawara-shi (JP)

(72) Inventors: Hiroki TAGUCHI, Otawara (JP); Shinsuke TSUKAGOSHI, Nasushiobara (JP); Yohei MINATOYA, Bunkyo (JP)

(73) Assignee: CANON MEDICAL SYSTEMS CORPORATION, Otawara-shi (JP)

(21) Appl. No.: 18/795,801

(22) Filed: Aug. 6, 2024

(30) Foreign Application Priority Data
Aug. 8, 2023 (JP) 2023-129012

(51) Int. Cl. G06T 7/00; G06T 7/38

(52) U.S. Cl. CPC G06T 7/0014; G06T 7/38

(57) ABSTRACT

A medical image processing apparatus includes processing circuitry that obtains 1st projection data of a 1st region with 1st dynamic data and 2nd projection data of a 2nd region with 2nd dynamic data; when the 1st and 2nd dynamic data exceed a threshold and match in magnitude of motion, extracts, from the 1st and 2nd projection dataset for an angular range at a time interval or for the magnitude, a 1st projection dataset and 2nd projection dataset, respectively; when the 1st and 2nd dynamic data exceed the threshold and differ in the magnitude, extracts the 1st projection dataset from the 1st projection data for the magnitude, and extracts the 2nd projection dataset for the same magnitude from the 2nd projection data; reconstructs 1st and 2nd volume data based on the 1st and 2nd projection datasets, respectively; and generates volume data concatenating the 1st and 2nd volume data.

### CROSS-REFERENCE TO RELATED APPLICATIONS

This application is based upon and claims the benefit of priority from Japanese Patent Application No. 2023-129012, filed on Aug. 8, 2023, the entire contents of which are incorporated herein by reference.

### FIELD

Embodiments described herein relate generally to a medical image processing apparatus and a medical image processing method.

### BACKGROUND

Among conventional imaging techniques using an X-ray computed tomography apparatus, there is dynamic imaging that captures the overall pulmonary field of a subject, for example, by dynamically and separately capturing the upper and lower lungs with an area detector. In such a conventional imaging technique, two pieces of volume data of the upper and lower lungs separately generated by dynamic imaging are concatenated together.

However, currently available area detectors has difficulty in capturing the entire pulmonary field by dynamic imaging at a time due to their sizes, for example. Thus, dynamic imaging of the pulmonary field needs to be performed twice or more. Further, to concatenate two or more pieces of volume data of the upper and lower lungs, it is necessary to separately capture the upper and lower lungs at the same breathing depth and speed. However, imaging the lungs twice or more at the same breathing depth and speed may be difficult. Because of this, dynamic images of larger areas such as the whole pulmonary field may be unsuitable for diagnosing.

### BRIEF DESCRIPTION OF THE DRAWINGS

FIG. 1 is a block diagram illustrating an exemplary configuration of an X-ray CT apparatus according to an embodiment;

FIG. 2 is a view illustrating the interior of a gantry according to an embodiment by way of example;

FIG. 3 is a view illustrating movements of an abdominal area along with respiratory movements according to an embodiment;

FIG. 4 is a view illustrating an exemplary exterior of a respiration sensor including a combination of a laser-length measuring machine and a laser controller according to an embodiment;

FIG. 5 is a view illustrating a relationship between a trigger signal and a respiratory waveform generated by a respiration sensor in one respiratory cycle according to an embodiment;

FIG. 6 is a graph illustrating a relationship between a trigger signal and a respiratory waveform generated by a respiration sensor in multiple respiratory cycles according to an embodiment;

FIG. 7 is a view illustrating one example of dynamic respiratory scanning according to an embodiment;

FIG. 8 is a graph illustrating another example of dynamic respiratory scanning according to an embodiment;

FIG. 9 is a graph illustrating another example of dynamic respiratory scanning according to an embodiment;

FIG. 10 is a graph illustrating one example of a first respiratory waveform and a second respiratory waveform at the same amplitude exceeding a threshold according to an embodiment;

FIG. 11 is a graph illustrating another example of a first respiratory waveform and a second respiratory waveform at the same amplitude exceeding a threshold according to an embodiment;

FIG. 12 is a graph illustrating one example of a first respiratory waveform and a second respiratory waveform at different, synchronous amplitudes according to an embodiment;

FIG. 13 is a graph illustrating one example of a first respiratory waveform and a second respiratory waveform in Case A according to an embodiment;

FIG. 14 is a graph illustrating one example of a first respiratory waveform and a second respiratory waveform in Case B according to an embodiment;

FIG. 15 is a flowchart illustrating exemplary steps of a concatenated-data generation process according to an embodiment; and

FIG. 16 is a flowchart illustrating another exemplary steps of a concatenated-data generation process according to an embodiment.

### DETAILED DESCRIPTION

According to one embodiment, a medical image processing apparatus includes processing circuitry. The processing circuitry obtains first projection data as to a first region of an imaging region of a subject together with first dynamic data representing motion of the subject, and obtain second projection data as to a second region of the imaging region together with second dynamic data representing the motion of the subject. The second region is different from the first region. When the first dynamic data and the second dynamic data both exceed a threshold and the first dynamic data and the second dynamic data match each other in magnitude of the motion of the subject, the processing circuitry extracts, from the first projection data, a first projection dataset corresponding to an angular range suited for image reconstruction at a predetermined time phase interval or according to the magnitude of the motion, and extracts, from the second projection data, a second projection dataset corresponding to the angular range at the predetermined time phase interval or the second projection dataset as to a same magnitude of the motion as the first projection dataset. When the first dynamic data and the second dynamic data both exceed the threshold and the first dynamic data and the second dynamic data differ from each other in the magnitude of the motion of the subject, the processing circuitry extracts the first projection dataset from the first projection data according to the magnitude of the motion, and extracts the second projection dataset as to the same magnitude of the motion as the first projection data from the second projection data. The processing circuitry reconstructs first volume data based on the first projection dataset and reconstructs second volume data based on the second projection dataset. The processing circuitry generates concatenated volume data as to the imaging region of the subject by concatenating the first volume data and the second volume data.

Hereinafter, embodiments of a medical image processing apparatus and a medical image processing method will be described in detail with reference to the accompanying drawings. According to one embodiment, a medical image processing apparatus is defined to be incorporated in an X-ray computed tomography (CT) apparatus herein. The medical image processing apparatus may be implemented as any of a variety of server systems such as a picture archiving and communication system (PACS) or an image interpretation system server, in addition to being incorporated in the X-ray CT apparatus.

Throughout this disclosure, parts, portions, elements, or functions denoted by the same reference numerals are considered to perform same or similar operations, and an overlapping explanation thereof will be omitted when appropriate. The present embodiment is not limited to the X-ray CT apparatus and may be implemented as a radiodiagnosis apparatus such as a complex system of an X-ray CT apparatus and a nuclear medicine diagnosis apparatus as positron emission tomography (PET) and single photon emission computed tomography (SPECT). In the following description, the X-ray CT apparatus is defined to be, but not limited to, an integrated X-ray CT apparatus. Alternatively, the X-ray CT apparatus may be implemented as a photon-counting X-ray CT apparatus.

The present embodiment is applicable to various types of X-ray CT apparatuses including a rotate/rotate type that an X-ray tube and an X-ray detector rotate around a subject in an integrated manner and a stationary/rotate type that a large number of X-ray detection elements are arranged in a ring form and an X-ray tube alone rotates around a subject. The X-ray CT apparatus is defined to be a rotate/rotate type herein.

The X-ray CT apparatus of the present embodiment further includes a dynamic-data acquisition apparatus that acquires dynamic data on a subject P. The dynamic-data acquisition apparatus acquires dynamic data representing a moving state of the subject P as data on motion of a subject. The dynamic data refers to data representing cyclic movements of the subject P, such as breathing or walking. In the following the dynamic data acquisition apparatus is defined to be a respiration sensor that measures respiration of a subject for the sake of specificity. The respiration sensor may also be referred to as a respiration monitoring apparatus that monitors breathing of a subject. The dynamic data acquisition apparatus is not limited to the respiration sensor and may be a known dynamic monitoring apparatus, for example, a camera that measures moving legs of a subject while walking. In such a case, a concatenated-data generation process, as described later, may be applied to, for example, the medical field of orthopedics.

### Embodiment

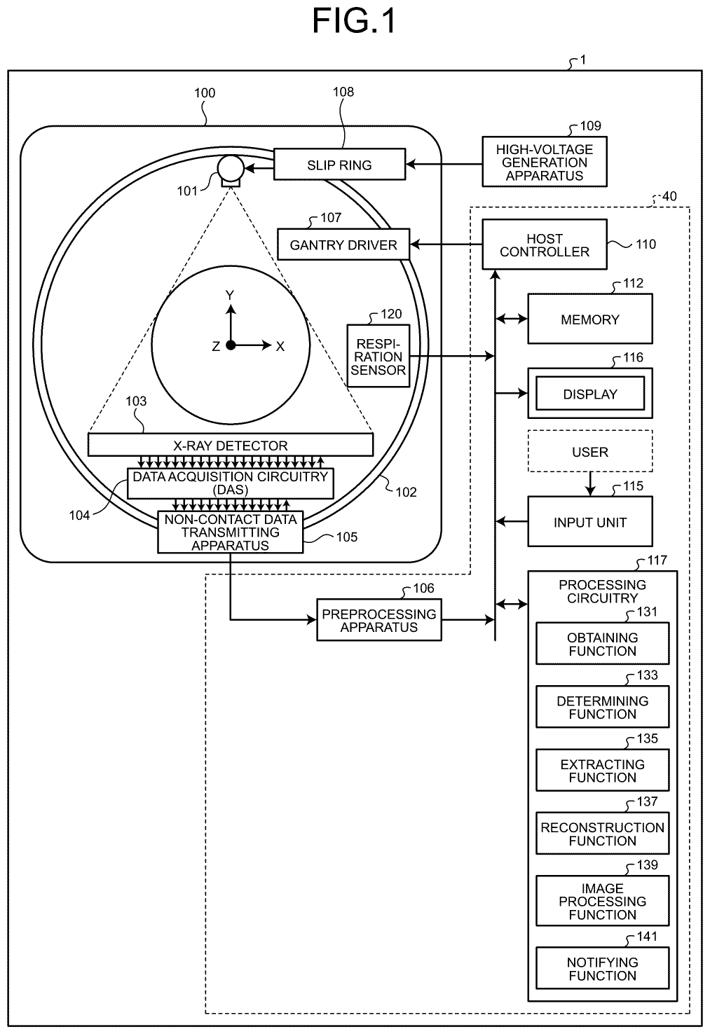

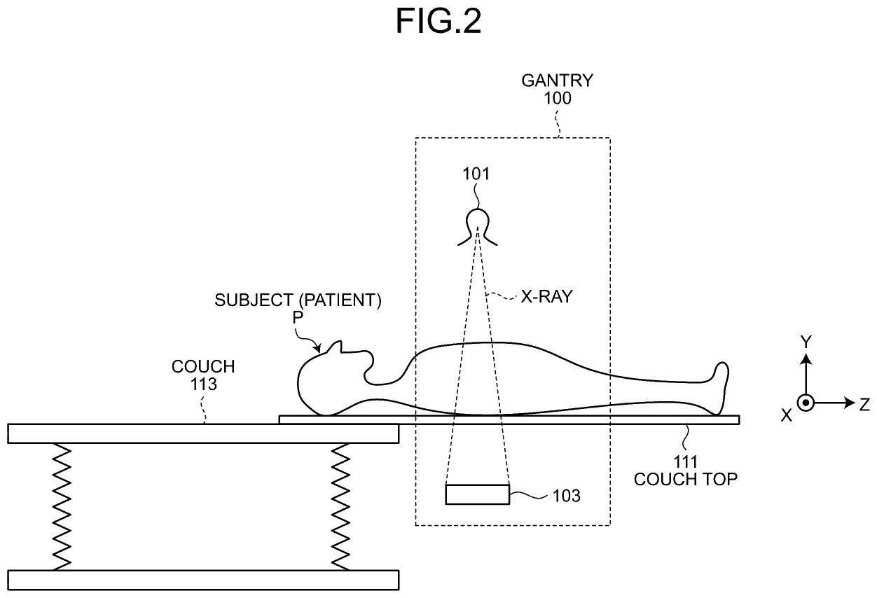

FIG. 1 illustrates an exemplary configuration of an X-ray CT apparatus 1 of an embodiment. As illustrated in FIG. 1, the X-ray CT apparatus 1 includes a gantry 100, a high-voltage generation apparatus 109, and a medical image processing apparatus 40. The high-voltage generation apparatus 109 may be incorporated in the gantry 100. A preprocessing apparatus 106 may be independently provided from the medical image processing apparatus 40. FIG. 2 shows the inside of the gantry 100 by way of example.

As illustrated in FIG. 1 and FIG. 2, the gantry 100 includes an annular or disc-shaped rotational frame 102 for scanning the subject P with X-rays. Being driven by a gantry driver 107, the rotational frame 102 rotates. The rotational frame 102 supports a corn-beam X-ray tube 101 and an X-ray detector (also referred to as a two-dimensional detector or area detector) 103 rotatably about the subject P. Specifically, on the rotational frame 102 the X-ray tube 101 and the X-ray detector 103 are disposed in opposing positions across an imaging region S around Z-axis. Under the control of a host controller 110 included in the medical image processing apparatus 40, the gantry driver 107 rotates the rotational frame 102 to rotate the X-ray tube 101 and the X-ray detector 103 about the subject P.

Note that the Z-axis is defined by the rotational axis of the rotational frame 102. Y-axis is defined by an axis connecting the X-ray focal point of the X-ray tube 101 and the center of the detection surface of the X-ray detector 103. Thus, the Y-axis is orthogonal to the Z-axis. X-axis is defined by an axis orthogonal to the Y-axis and the Z-axis. As such, the XYZ orthogonal coordinate system serves as a rotational coordinate system that rotates along with the X-ray tube 101.

Being applied with a high voltage from the high-voltage generation apparatus 109, the X-ray tube 101 generates X-rays of a corn form. The X-ray tube 101 is, for example, a vacuum tube to be applied with a high voltage and supplied with a filament current from the high-voltage generation apparatus 109 to generate X-rays by emitting thermoelectrons from a negative pole (filament) to a positive pole (target). The X-rays are generated as a result of collision between the thermoelectrons and the target. The X-rays are generated at the focal point of the X-ray tube 101, pass through an X-ray emission window thereof, and are formed into, for example, a cone beam through a collimator and emitted to the subject P. Examples of the X-ray tube 101 include a rotating anode X-ray tube that generates X-rays by emitting thermoelectrons onto a rotating positive pole.

The high-voltage generation apparatus 109 applies a high voltage to the X-ray tube 101 under the control of the host controller 110. The high-voltage generation apparatus 109 includes electric circuitry such as a transformer and a rectifier, high-voltage generator circuitry that generates a high voltage to be applied to the X-ray tube 101 and a filament current to be supplied to the X-ray tube 101, and an X-ray controller that controls the output voltage in accordance with the X-rays emitted from the X-ray tube 101. The high-voltage generation apparatus 109 may be a transformer type or an inverter type. Further, the high-voltage generation apparatus 109 may be disposed in the rotational frame 102 or in the stationary frame of the gantry 100. The high-voltage generation apparatus 109 may be referred to as an X-ray high-voltage apparatus.

A slip ring 108 is an element for feeding electric power from the stationary frame to the elements in the rotational frame 102. The slip ring 108 is, for example, disposed in the rotational frame 102. The slip ring 108 is supplied with electric power via a power feeding brush provided in the stationary frame.

The X-ray detector 103 detects an X-ray emitted from the X-ray tube 101 and having passed through the subject P to generate an electric signal corresponding to the intensity of the X-ray. A detector type such as a surface detector and a multi-array detector is preferable for the X-ray detector 103. The X-ray detector 103 of this type includes multiple two-dimensional arrays of X-ray detection elements. For example, 1,000 X-ray detection elements are arrayed along an arc about the Z-axis. The direction in which the X-ray detection elements are arrayed is referred to as a channel direction. The X-ray detection elements arrayed in the channel direction are referred to as X-ray detection element arrays. For example, 64 or 320 detection element arrays are arranged in a slice direction indicated by the Z-axis. The X-ray detector 103 is connected to data acquisition circuitry (data acquisition system: DAS) 104.

The data acquisition circuitry 104 retrieves a current signal for each channel from the X-ray detector 103 under the control of the host controller 110. The data acquisition circuitry 104 amplifies and converts each current signal into a digital signal to generate projection data. The resultant projection data is supplied to the medical image processing apparatus 40 via a non-contact data transmitting apparatus 105. The data acquisition circuitry 104 includes, for each channel, an I-V converter that converts the current signal of each channel of the X-ray detector 103 into a voltage signal, an integrator that periodically integrates voltage signals in synchronization with an X-ray irradiation cycle, an amplifier that amplifies output signals from the integrator, and an A/D converter that converts the output signals from the amplifier to digital signals.

A couch 113 is placed in the vicinity of the gantry 100. The couch 113 includes a couch top 111, a couch-top support mechanism, and a couch-top driver. The subject P is to be laid on the couch top 111. The couch-top support mechanism movably supports the couch top 111 along the Z-axis. The couch-top support mechanism typically supports the couch top 111 such that the longitudinal axis of the couch top 111 is set parallel to the Z-axis. For example, the couch-top driver drives the couch-top support mechanism to move the couch top 111 in the Z-axis direction under the control of the host controller 110.

The medical image processing apparatus 40 is connected to a respiration sensor 120 via, for example, a cable. The respiration sensor 120 measures the respiratory motion of the subject P. Typically, for the respiratory motion measurement, the respiration sensor 120 measures the motion of the abdominal area of the subject P along with his or her respiratory motion.

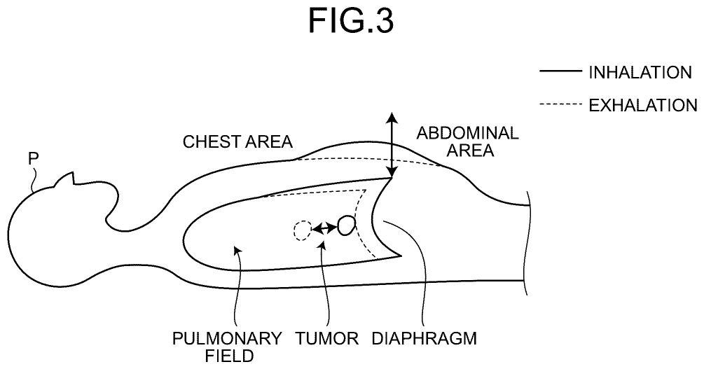

FIG. 3 is a view illustrating the movement of an abdominal area along with respiratory motion. As illustrated in FIG. 3, the abdominal area generally inflates by inhalation and deflates by exhalation. Along with the respiratory motion, the internal organs change in position and shape. For example, the pulmonary field greatly changes in position and shape due to breathing. Thus, a tumor occurring in the pulmonary field also greatly changes in position along with breathing. Herein, a length of time from an inhalation to the next inhalation is referred to as a respiratory cycle. The respiratory cycle is not constant but varies depending on how the subject P breathes, therefore, every respiratory cycle differs in length. In the present embodiment, the respiratory cycle may also be defined as a length of time from an exhalation to the next exhalation, for example, in addition to the above definition.

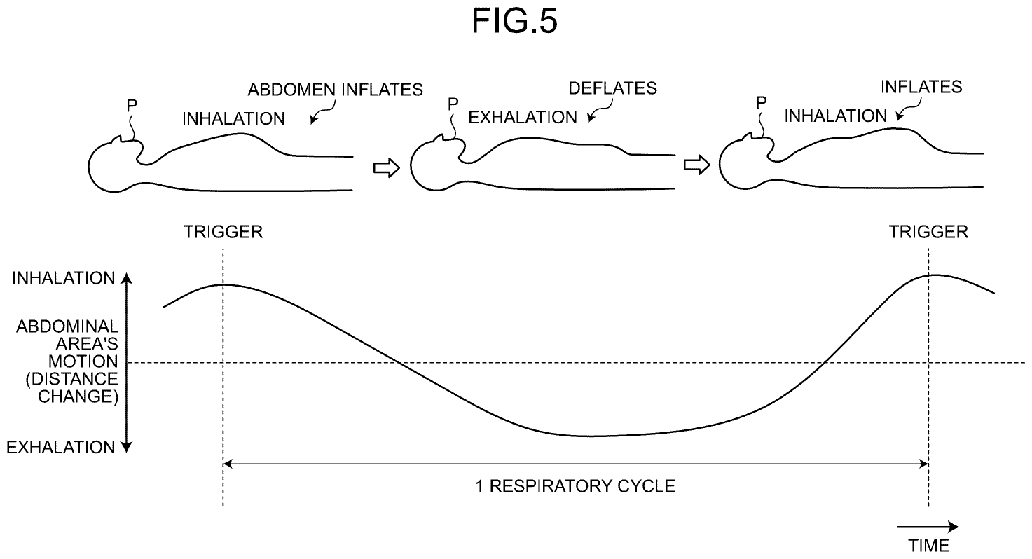

The respiration sensor 120 can be, for example, a combination of a laser-length measuring machine that measures the abdominal motion of the subject P with laser and a laser controller that controls the laser. The laser controller can be implemented by an existent computer, for instance. The respiration sensor 120 may be disposed in the X-ray CT apparatus 1 to serve as a respiratory-phase measuring system that measures the respiratory phase of the subject P, for example. The respiratory-phase measuring system functions to measure the respiratory movements of the subject P as shown in FIG. 3 and FIG. 5. As well known, the respiratory movements are the inflation and deflation of the pulmonary field along with the reciprocative movements of the diaphragm. The abdominal area moves forward and backward in a reciprocative manner as the pulmonary field inflates and deflates.

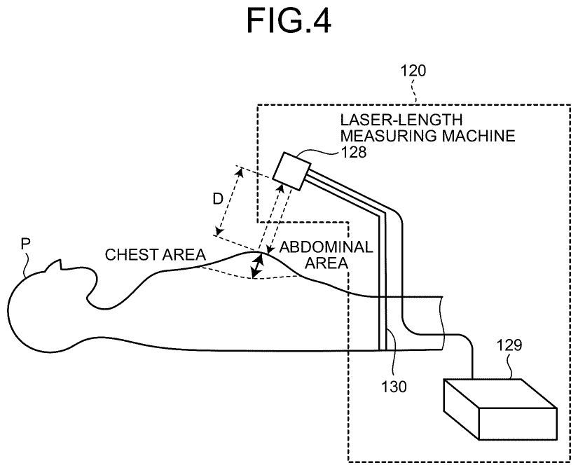

FIG. 4 illustrates the exterior of the respiration sensor 120 including a laser-length measuring machine 128 and a laser controller 129 in combination, by way of example. The laser controller 129 includes laser-control processing circuitry and memory, for example. As illustrated in FIG. 4, the laser-length measuring machine 128 of the respiration sensor 120 is supported by a multi-joint arm 130 installed on the couch top 111, for example, to detect the reciprocative movements of the abdominal area. The laser-length measuring machine 128 includes, for example, a laser generator and a light receiver. A user can adjust the angles of the respective joints of the multi-joint arm 130 so as to place the laser-length measuring machine 128 in right position and orientation to be able to emit laser in substantially parallel with the direction of the abdominal reciprocative movements of the subject P.

As illustrated in FIG. 4, the laser controller 129 causes the laser generator and the light receiver of the laser-length measuring machine 128 to operate. At the same time, the laser controller 129 processes signals of reflected light by the abdominal surface of the subject P to iteratively calculate the distance D between the laser generator and the abdominal surface of the subject P in real time in accordance with a length of time from the laser irradiation to reception of the reflected light or a phase variation in the reflected light signals. The laser controller 129 typically monitors the distance between the laser generator and the abdominal surface of the subject P in real time to generate a respiratory waveform representing a temporal variation in distance measurements. Further, while monitoring the measurements in real time, the laser controller 129 generates a trigger signal, triggered by an event that the subject P's respiratory motion has reached a particular respiratory phase on the respiratory waveform. The trigger signal is set such that the trigger signal occurs in a particular one of multiple respiratory phases. Respiratory waveform data and trigger signals are supplied to the medical image processing apparatus 40 of the X-ray CT apparatus 1.

The respiration sensor 120 may include a band and a pressure sensor and be for such use that the band is strapped to the subject's abdominal area and the pressure sensor is attached to a location in-between the band and the abdominal area, to be able to observe his or her breathing state from a variation in pressure. Alternatively, the respiration sensor 120 may include an optical reflective member and a camera. The optical reflective member may be attached to a material placed on the abdominal area and be captured by the camera, to observe a breathing state from the motion of a part of the optical reflective member. The respiration sensor 120 can be any type of device other than the above examples as long as it can observe respiratory inhalation and exhalation states.

FIG. 5 illustrates an exemplary relationship between a trigger signal and a respiratory waveform generated by the respiration sensor 120 in one respiratory cycle. As illustrated in FIG. 5, the respiratory waveform is depicted as a graph with the horizontal axis representing time and the vertical axis representing measurements. The measurements are, for example, set such that the higher the position of the abdominal surface, the higher the value, and the lower the position of the abdominal surface, the lower the value. The measurements are represented as crest values indicating distances between the abdominal surface of the subject P and the laser generator that iteratively emits laser as instructed by the laser controller 129.

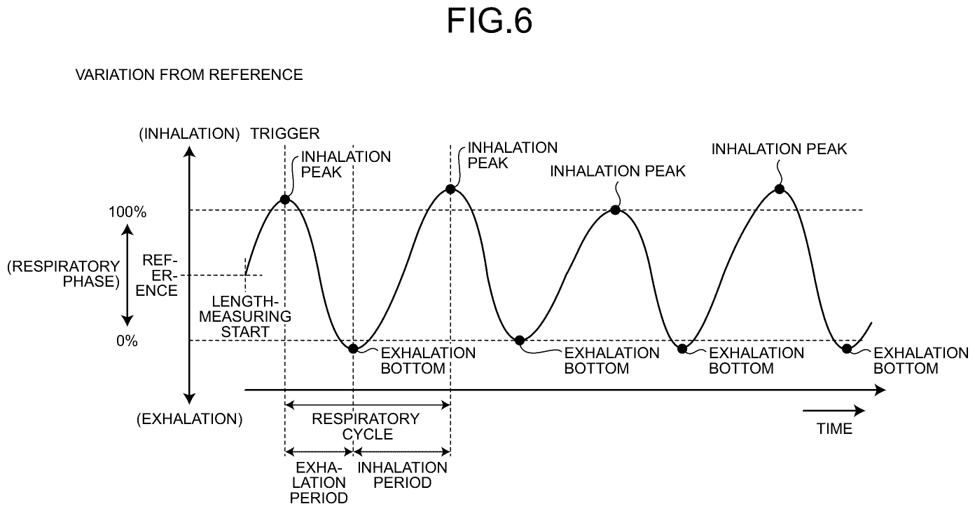

FIG. 6 illustrates an exemplary relationship between a trigger signal and a respiratory waveform generated by the respiration sensor 120 in multiple respiratory cycles. In FIG. 5 and FIG. 6, the crest value, representing the distance, heightens during inhalation and lowers during exhalation, however, the relation between the respiration and the crest value is not limited to such an example. Herein, the example that the crest value heightens during inhalation and lowers during exhalation is explained. Further, the respiratory waveform may represent not a variation in absolute distance value but a temporal variation in change of distance from a reference distance which is defined to be a distance at the time of start of measuring, for example.

The trigger signal occurs, being triggered by, for example, an event that the measurement has reached or almost reached a peak of the respiratory waveform. In this case the trigger signal represents a respiratory phase where the subject P most deeply inhales. The laser controller 129 may overlay a trigger mark on the respiratory waveform for display on the monitor of the respiration sensor 120.

The respiration sensor 120 of the present embodiment is not limited to the type including the laser-length measuring machine 128. For example, the respiration sensor 120 may be a pressure sensor type. In this case the pressure sensor is attached to a location in-between the subject P's abdominal area and a band strapped to the abdominal area. The pressure sensor iteratively measures the pressure acting on the location in-between the abdominal area and the band. The resulting measurements are supplied to a computer connected to the pressure sensor. The computer works to measure the respiratory motion by measuring a variation in pressure while monitoring the measurements from the pressure sensor.

For another example, the respiration sensor 120 may be an optical camera type. In this case the optical camera repetitively captures an optical reflective member disposed on the abdominal area. Image data is supplied from the optical camera to a computer connected to the optical camera. The computer measures the respiratory motion by measuring movements of the optical reflective member while monitoring the position of the optical reflective member based on the image data from the optical camera.

However, the respiration sensor 120 of the present embodiment is not limited to the above types. The respiration sensor 120 can be any type of device as long as it can measure the respiratory motion (states of exhalation and inhalation) of the subject P.

The medical image processing apparatus 40 includes the preprocessing apparatus 106, the host controller 110, a memory 112, an input unit 115, a display 116, and processing circuitry 117. The processing circuitry 117 includes an obtaining function 131, a determining function 133, an extracting function 135, a reconstruction function 137, an image processing function 139, and a notifying function 141. In some case, the processing circuitry 117 may implement the processing implemented by the preprocessing apparatus 106. In such a case the processing circuitry 117 includes a preprocessing function performed by the preprocessing apparatus 106, therefore, the preprocessing apparatus 106 is omissible.

The preprocessing apparatus 106 performs preprocessing to the data detected by the data acquisition circuitry 104. The preprocessing includes correcting uneven sensitivity among the channels or correcting an extreme drop in signal intensity or a signal dropout due to an X-ray strong absorber, mainly a metal part thereof. The data (projection data) having undergone the preprocessing by the preprocessing apparatus 106 is stored in the memory 112. Under the control of the host controller 110, the projection data becomes associated with various kinds of attribute information as to data acquisition positions and timing, such as time code representing data acquisition time, channel-number code, viewing-angle code, rotation-rate code, and counter-top-position code.

The host controller 110 performs control over the gantry driver 107, the high-voltage generation apparatus 109, the data acquisition circuitry 104, and the preprocessing apparatus 106 to perform scanning according to a scan condition set via the input unit 115. Further, the host controller 110 controls the processing circuitry 117 to reconstruct volume data according to a reconstruction condition set via the input unit 115. In some case the processing circuitry 117 may implement the various functions performed by the host controller 110. In such a case, the processing circuitry 117 includes, for example, a system control function that implements the functions of the host controller 110. The processing circuitry 117 implementing the system control function and the host controller 110 correspond to a system control unit.

The host controller 110 preforms a scanning method particular to the present embodiment, i.e., dynamic scanning synchronized with the respiration (hereinafter, referred to as respiration-synchronous dynamic scan), to perform a dynamic scan in about one respiratory cycle. In response to a trigger signal arising from a particular respiratory phase in a respiratory waveform representing the respiratory motion of the subject P, for example, the host controller 110 performs a respiration-synchronous scan of the subject P in synchronization with the respiratory motion.

Specifically, in order to dynamically scan the subject P in approximately one respiratory cycle (that is, to iteratively scan the same scan region in approximately one respiratory cycle while the scan position remains unchanged), the host controller 110 controls the X-ray emission from the X-ray tube 101 and the projection data acquisition by the data acquisition circuitry 104, in synchronization with the trigger signal from the respiration sensor 120.

In addition, the host controller 110 controls the X-ray emission from the X-ray tube 101, the projection-data acquisition by the data acquisition circuitry 104, and intermittent movements of the couch top 111 of the couch 113 in synchronization with the trigger signal from the respiration sensor 120, in order to dynamically scan each of scan regions of the subject P in approximately one respiratory cycle (that is, to iteratively scan the subject P at each scan position in approximately one respiratory cycle while intermittently move the couch top 111 to each scan position, in other words, to repeat a dynamic scan and a couch top movement). Thus, the host controller 110 performs, as a respiration-synchronous scan, a volume scan (respiration-synchronous dynamic scan) of a first region and a second region of the imaging region of the subject P.

The memory 112 is a storage that stores various kinds of information, such as a hard disk drive (HDD), a solid state drive (SSD), or an integrated circuit storage device. The memory 112 can be a driver that reads and writes various kinds of information from and to a portable storage medium as a compact disc (CD)-ROM drive, a digital versatile disc (DVD) drive, or a flash memory or a semiconductor memory device such as random access memory (RAM), in addition to a HDD or an SDD. The storage area of the memory 112 may be provided in the medical image processing apparatus 40 as illustrated in FIG. 1 or in an external storage connected via a network. The memory 112 stores therein the projection data preprocessed by the preprocessing apparatus 106. The memory 112 also stores respiratory waveforms. Specifically, the memory 112 stores the projection data in association with phases of the respiratory waveform (e.g., crest values of the respiratory waveform).

The input unit 115 may be implemented by an input interface. The input interface receives various kinds of user instructions and information inputs. Examples of the input interface include a trackball, a switch button, a mouse, a keyboard, a touchpad that allows inputs by touch on the operation surface, a touch screen as an integrated display screen and touch pad, non-contact input circuitry including an optical sensor, and audio input circuitry. The input interface receives and converts user inputs into electrical signals and output the electrical signals to the processing circuitry 117. Herein, the input interface is not limited to the one including a physical operational component such as a mouse or a keyboard. Examples of the input interface further include electrical-signal processing circuitry that receives an electrical signal corresponding to an operational input from an external input device separated from the medical image processing apparatus 40 to output the electrical signal to the processing circuitry 117.

The display 116 displays display images. The display 116 also displays a setting screen that allows the user to set a scanning plan for a respiration-synchronous dynamic scan. Examples of the display 116 include a cathode ray tube (CRT) display, a liquid crystal display (LCD), an organic electroluminescence display (OELD), a plasma display, or any other display when appropriate. The display 116 may also be referred to as a display device or a monitor. The display 116 displays the respiratory waveform together with a sagittal image and/or a coronal image in juxtaposition. In addition, the display 116 may further display an axial image in juxtaposition. The display 116 may further display the position of the couch top 111 in the longitudinal direction (Z-direction) with respect to the respiratory waveform.

The processing circuitry 117 includes, for example, hardware resources including a processor such as a CPU, an MPU, or a graphics processing unit (GPU) and memory such as ROM and RAM. The processing circuitry 117 uses the processor that loads and executes programs on the memory, to implement the obtaining function 131, the determining function 133, the extracting function 135, the reconstruction function 137, the image processing function 139, and the notifying function 141. The respective functions may not be implemented by a single piece of processing circuitry. The processing circuitry can be constituted of a combination of multiple independent processors, so that the processors can individually execute the programs to implement the respective functions.

In the following, the imaging region for the respiration-synchronous dynamic scan is defined to be the pulmonary field of the subject P for the sake of specificity. The imaging region includes a first region corresponding to the upper lung of the subject P and a second region corresponding to the lower lung of the subject P. The first region and the second region are defined to partially overlap each other. The imaging region may include three or more regions, in place of the two first and second regions.

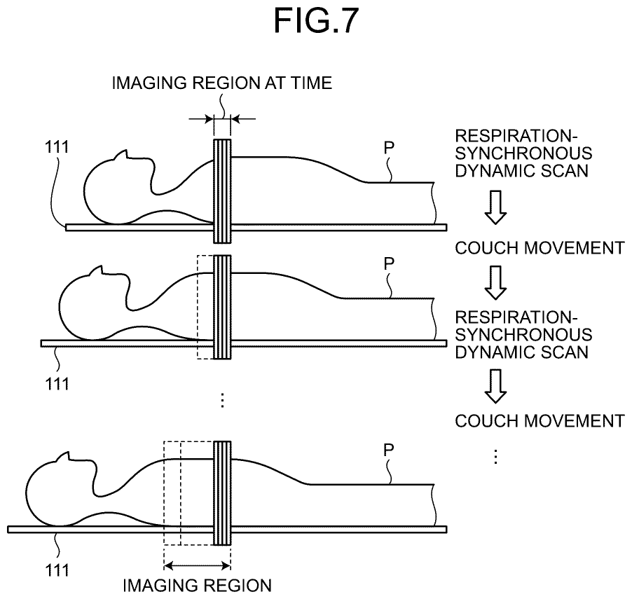

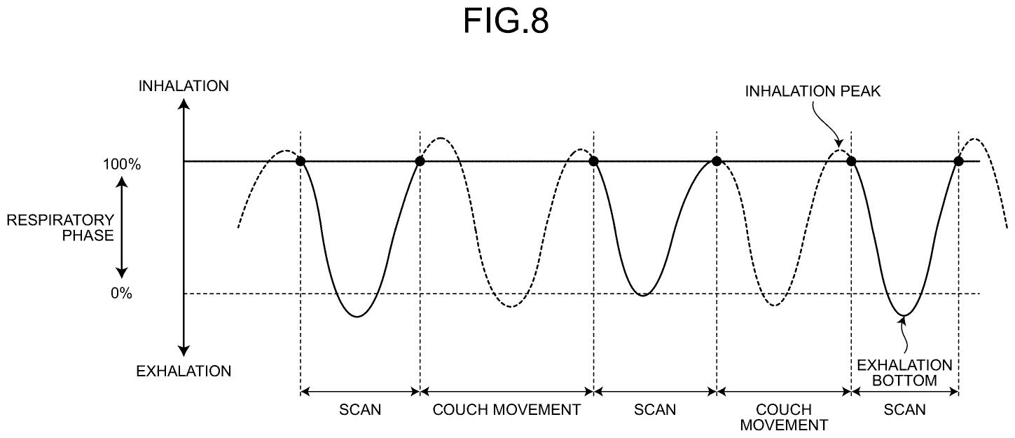

FIG. 7 to FIG. 9 illustrate one example of dynamic respiratory scanning. As illustrated in FIG. 7 and FIG. 8, in a respiration-synchronous dynamic scan, scans and movements of the couch top of the couch 113 are alternatively iterated. A single couch-top moving distance (unit distance) is set to a Z-axial relative distance according to an X-ray corn angle in the Z-axial range of sensitivity of the X-ray detector 103, for the purpose of allowing pieces of projection data to be continuous without any gap (blank segment) in the Z-axis direction.

In accordance with the crest-value data output from the respiration sensor 120, the host controller 110 iteratively performs scanning with X-ray irradiation during a period from a time at which the crest value exceeds an inhalation peak and initially reaches a value corresponding to, e.g., the respiratory phase of 100% to a time at which the crest value passes an exhalation bottom (the minimum value of the respiratory waveform) and initially reaches a value corresponding to the same respiratory phase. Alternatively, the host controller 110 may repeat scanning along with X-ray irradiation during a period from a time at which the crest value passes an exhalation bottom and initially reaches a value corresponding to, e.g., the respiratory phase of 0% to a time at which the crest value exceeds an inhalation peak and initially reaches a value corresponding to the same respiratory phase.

Next, the host controller 110 causes the couch top 111 to move, with the X-ray irradiation suspended. The X-ray tube 101 typically continues to be rotated while the couch top is being moved. After the couch top 111 has moved by the unit distance and stopped, the host controller 110 then iteratively performs scans with X-ray irradiation during a period in the respiratory cycle from a time at which the crest value initially reaches a value corresponding to the respiratory phase of 100% to a time at which the crest value reaches a value corresponding to the same respiratory phase next. In this manner the host controller 110 acquires projection data across the entire imaging region in synchronization with the respiration cycle while alternatively performing scans and couch-top movements.

Projection datasets are extracted for image reconstruction. In the extraction process a projection dataset is extracted from the projection data generated by each scan. The projection dataset corresponds to 360° or 180° plus a fan angle, the 360° or 180° angle centering around a time at predetermined time intervals or a time at predetermined intervals of magnitude of motion (crest values of the respiratory waveform). The process of extracting a projection dataset from projection data will be described later.

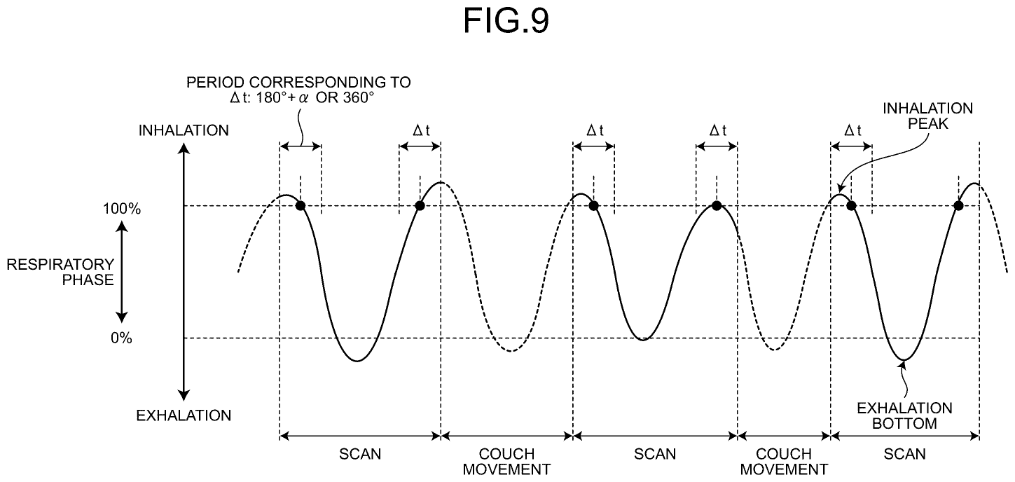

In addition, the scan period may be, for example, extended forward and backward as illustrated in FIG. 9 from the one in FIG. 8, so that projection data corresponding to 360° or 180° plus a fan angle, which centers around a time at an end of the scan period, i.e., the respiratory phase of 100%, is constantly obtained. The extended period corresponds to a time Δt taken for the X-ray tube 101 to rotate by 180° or 90°+(fan angle/2).

The processing circuitry 117 uses the obtaining function 131 to obtain first projection data concerning the first region of the imaging region of the subject P together with first dynamic data representing motion of the subject P. When the imaging region is set to the pulmonary field of the subject P, the motion of the subject P is respiratory motion, and the first dynamic data corresponds to a first respiratory waveform. The first projection data is generated by a first scan of the first region of the imaging region. The obtaining function 131 obtains the first projection data as to the first region from the preprocessing apparatus 106 and obtains the first respiratory waveform for a first-projection-data acquisition period from the respiration sensor 120 at the same time. The obtaining function 131 stores the first projection data and the first respiratory waveform in the memory 112 in association with each other. The first projection data of the first region is obtained during, for example, at least one cycle of the first respiratory waveform.

The processing circuitry 117 uses the obtaining function 131 to obtain second projection data concerning the second region of the imaging region of the subject P together with second dynamic data representing motion of the subject P. When the imaging region is set to the pulmonary field of the subject P, the motion of the subject P is respiratory motion, and the second dynamic data corresponds to a second respiratory waveform. The second projection data is generated by a second scan of the second region of the imaging region. The obtaining function 131 obtains the second projection data of the second region from the preprocessing apparatus 106 and obtains the second respiratory waveform for a second-projection-data acquisition period from the respiration sensor 120 at the same time. The obtaining function 131 stores the second projection data and the second respiratory waveform in the memory 112 in association with each other. The second projection data about the second region is obtained during, for example, at least one cycle of the second respiratory waveform in the same time phase as that of the first respiratory waveform. The processing circuitry 117 implementing the obtaining function 131 corresponds to an obtainer unit.

The processing circuitry 117 uses the determining function 133 to determine whether the first respiratory waveform and the second respiratory waveform both exceed a threshold. The threshold represents a predetermined breathing depth of the subject P in the first and second projection-data acquisition periods. In other words, the determining function 133 determines whether the first respiratory waveform and the second respiratory waveform both exceed the predetermined breathing depth, i.e., whether subject P is breathing more deeply than the predetermined depth. The processing circuitry 117 implementing the determining function 133 corresponds to a determiner unit.

In addition, the processing circuitry 117 uses the determining function 133 to determine whether the magnitudes of the motion of the subject P indicated by the first respiratory waveform and by the second respiratory waveform match each other. The magnitude of the motion of the subject P in the first respiratory waveform corresponds to the magnitude of amplitude of the first respiratory waveform, that is, a breathing depth. Similarly, the magnitude of the motion of the subject P in the second respiratory waveform corresponds to the magnitude of amplitude of the second respiratory waveform, that is, a breathing depth. In other words, the determining function 133 determines whether the first respiratory waveform and the second respiratory waveform are at approximately the same degree of depth (breathing depth within a designated range). Further, the determining function 133 determines whether the first respiratory waveform and the second respiratory waveform are synchronized with each other.

When determining that the first respiratory waveform and the second respiratory waveform both exceed the threshold and match with each other in amplitude (i.e., breathing depth) (hereinafter, referred to as same threshold-exceeding amplitude), the processing circuitry 117 uses the extracting function 135 to extract a first projection dataset, which corresponds to an angular range suited for image reconstruction, from the first projection data based on the first respiratory waveform at a predetermined time phase interval or in accordance with the magnitude of the amplitude. The extracting function 135 extracts, from the second projection data, a second projection dataset corresponding to the same angular range based on the second dynamic data at the same predetermined time phase interval or in accordance with the same magnitude of the motion (the same magnitude of amplitude).

Specifically, at the same threshold-exceeding amplitude, the extracting function 135 extracts a plurality of first projection datasets from the first projection data in correspondence with multiple time phases or multiple amplitudes in the first respiratory waveform. Similarly, at the same threshold-exceeding amplitude, the extracting function 135 extracts a plurality of second projection datasets from the second projection data at the same time phase intervals or at the same amplitudes as in the first respiratory waveform. The extracting function 135 then stores the extracted first projection datasets and second projection datasets in a time series in the memory 112 together with the first respiratory waveform and the second respiratory waveform. The processing circuitry 117 implementing the extracting function 135 corresponds to an extractor unit.

More specifically, with the same threshold-exceeding amplitude and the first respiratory waveform and the second respiratory waveform in mutual synchronization, the processing circuitry 117 uses the extracting function 135 to extract first projection datasets from the first projection data at the predetermined time phase intervals based on the first respiratory waveform, and extracts second projection datasets from the second projection data at the same time phase intervals based on the second respiratory waveform.

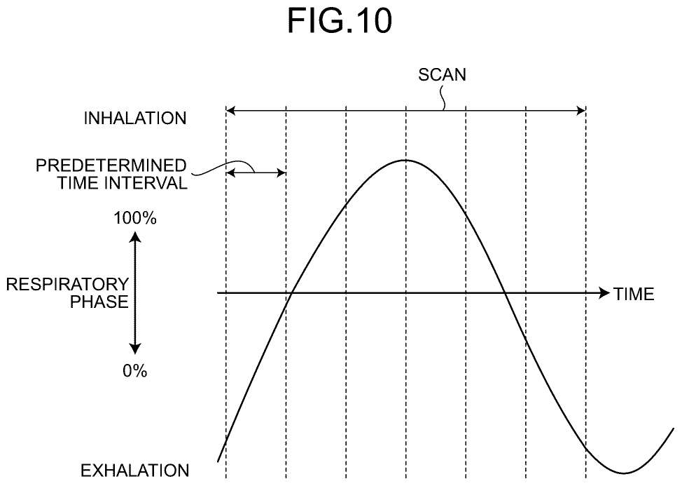

FIG. 10 illustrates an example of the first respiratory waveform and the second respiratory waveform at the same threshold-exceeding amplitude. As illustrated in FIG. 10, the same threshold-exceeding amplitude represents successful scans of the upper and lower lungs at the same depth exceeding a preset depth. In addition, the first respiratory waveform and the second respiratory waveform are synchronized with each other in FIG. 10. Thus, FIG. 10 depicts an event that the upper and lower lungs have been captured for the same length of time along the time axis. In this case the extracting function 135 can extract first projection datasets from the first projection data and second projection datasets from the second projection data at the same predetermined time intervals since the first respiratory waveform and the second respiratory waveform match each other in terms of time phase and breathing depth, as illustrated in FIG. 10.

Further, with the same threshold-exceeding amplitude and the first respiratory waveform and the second respiratory waveform in non-synchronization, the extracting function 135 extracts a first projection dataset from the first projection data at a predetermined interval of motion of the subject P, and extracts a second projection dataset representing the same motion of the subject P represented in the first projection dataset from the second projection data with reference to the second dynamic data.

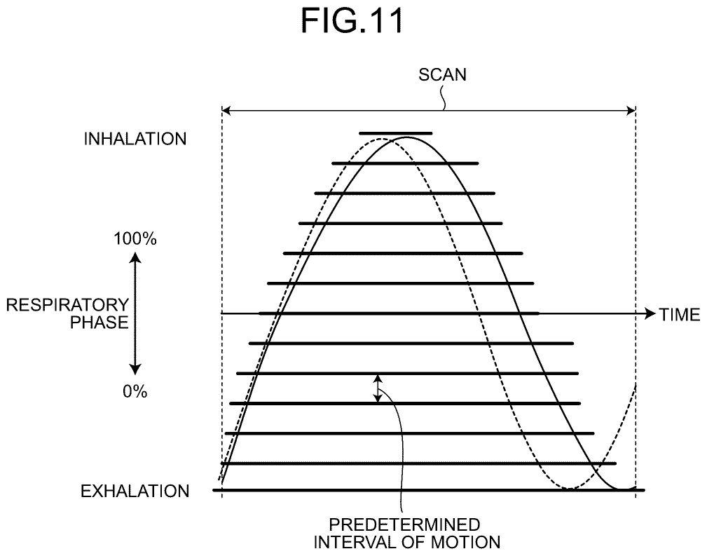

FIG. 11 illustrates another example of the first respiratory waveform and the second respiratory waveform at the same threshold-exceeding amplitude. As illustrated in FIG. 11, the same threshold-exceeding amplitude represents successful scans of the upper and lower lungs at the same depth exceeding a preset depth. In addition, the first respiratory waveform and the second respiratory waveform are asynchronous with each other in FIG. 11. Thus, the first respiratory waveform and the second respiratory waveform shift in phase along the time axis and one is faster and the other is slower as illustrated in FIG. 11. However, due to the same breathing depth in FIG. 11, the extracting function 135 can extract a first projection dataset from the first projection data at the predetermined interval of motion, i.e., at a predetermined respiratory phase interval along the longitudinal axis of FIG. 11, and extracts a second projection dataset representing the same motion of the subject P (same respiratory phase) as the first projection dataset from the second projection data.

When determining that the first respiratory waveform and the second respiratory waveform exceed the threshold and differ in amplitude (breathing depth or magnitude) (hereinafter, referred to as different threshold-exceeding amplitudes), the processing circuitry 117 uses the extracting function 135 to extract a first projection dataset from the first projection data in accordance with the magnitude of motion (respiratory waveform) of subject P based on the first respiratory waveform, and extract a second projection dataset representing the same magnitude of motion as the first projection dataset from the second projection data based on the second respiratory waveform.

Specifically, with the different threshold-exceeding amplitudes and the first respiratory waveform and the second respiratory waveform in mutual synchronization (hereinafter, referred to as Case A), the extracting function 135 identifies multiple time phases at the same amplitude in the first respiratory waveform and the second respiratory waveform. The extracting function 135 then extracts a plurality of first projection datasets corresponding to the identified time phases from the first projection data, and extracts a plurality of second projection datasets corresponding to the identified time phases from the second projection data. The extracting function 135 then stores the extracted first projection datasets and second projection datasets in a time series in the memory 112 along with the first respiratory waveform and the second respiratory waveform. Hereinafter, such an extraction process in Case A will be referred to as depth-prioritized extraction.

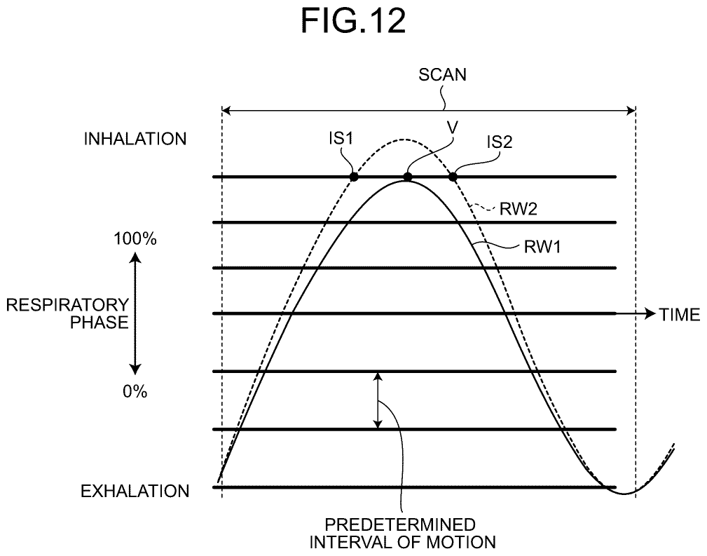

FIG. 12 illustrates an example of the first respiratory waveform and the second respiratory waveform at the different threshold-exceeding amplitudes. As illustrated in FIG. 12, the different threshold-exceeding amplitudes represents successful scans of the upper and lower lungs at different depths exceeding a preset depth. In addition, the first respiratory waveform and the second respiratory waveform are synchronous with each other in FIG. 12. Thus, FIG. 12 depicts an event that the upper and lower lungs have been captured for the same length of time along the time axis. In this case the extracting function 135 extracts first projection datasets and second projection datasets from the first projection data and the second projection data, respectively, in the same manner as in the example of FIG. 11.

In FIG. 12 the respiratory waveform (indicated by the solid line) having a smaller maximum respiratory phase is referred to as a first respiratory waveform RW1. The horizontal lines in the graph of FIG. 12 represent predetermined intervals of motion which are set based on a time phase corresponding to the maximum respiratory phase, i.e., the peak of the solid-line respiratory waveform. The extracting function 135 identifies multiple time phases at the intersections between the first respiratory waveform RW1 and the horizontal lines (values of respiratory positions), except for the peak V of the first respiratory waveform RW1. The extracting function 135 then extracts, as the first projection dataset, at each of the time phases, projection data included in the angular range centering around the angle corresponding to each of the time phases.

In addition, in FIG. 12 the second projection dataset corresponding to the peak V of the first respiratory waveform RW1 is, for example, projection data included in the angular range centering around the angle corresponding to at least one time phase of the two intersections (IS1, IS2) between the same respiratory phase (horizontal line) as that of the peak V of the first respiratory waveform RW1 and a second respiratory waveform RW2. As an example, the processing circuitry 117 uses the extracting function 135 to extract, from the second projection data, as a second projection dataset, for example, second projection data in the angular range about the angle corresponding to the time phase of the first intersection IS1 (hereinafter, first-intersection projection data) or second projection data in the angular range about the angle corresponding to the time phase of the second intersection IS2 (hereinafter, second-intersection projection data).

Alternatively, the processing circuitry 117 may use the extracting function 135 to calculate, for example, an average of the first-intersection projection data and the second-intersection projection data at each of the angles of the angular range as a second projection dataset. Further, the extracting function 135 may calculate a second projection dataset by weighed addition or weighted averaging of the first-intersection projection data and the second-intersection projection data in line with a distance from the peak V of the first respiratory waveform RW1 to the first intersection IS1 and a distance from the peak V of the first respiratory waveform RW1 to the second intersection IS2.

In Case A, the processing circuitry 117 may use the extracting function 135 to extract first projection datasets from the first projection data at predetermined time phase intervals with reference to the first respiratory waveform, and extract second projection datasets from the second projection data at the same predetermined time phase intervals with reference to the second respiratory waveform. Such an extraction process in Case A will be referred to as time-prioritized extraction below.

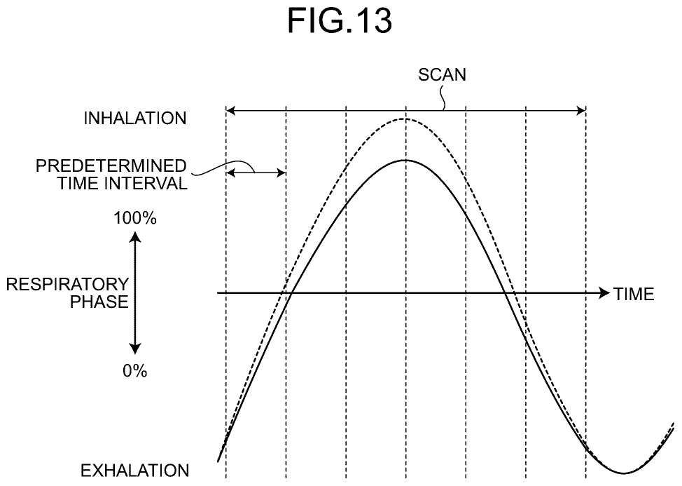

FIG. 13 illustrates an example of the first respiratory waveform and the second respiratory waveform in Case A. As illustrated in FIG. 13, the different threshold-exceeding amplitude represents successful scans of the upper and lower lungs at different depths exceeding a preset depth. In addition the first respiratory waveform and the second respiratory waveform are synchronous with each other in FIG. 13. FIG. 13 depicts an event that the upper and lower lungs have been captured for the same length of time along the time axis, similar to FIG. 12.

In Case A, the depth-prioritized extraction and the time-prioritized extraction are set or selected, for example, according to an examination order for the subject P. For a non-contrast examination order, for example, the depth-prioritized extraction is set and performed. The time-prioritized extraction may be then performed following the depth-prioritized extraction. For a contrast examination order, the time-prioritized extraction is performed. The depth-prioritized extraction may be then performed following the time-prioritized extraction. Alternatively, the depth-prioritized extraction and/or the time-prioritized extraction may be selected according to a user instruction given via the input unit 115. The selection of the depth-prioritized extraction and/or the time-prioritized extraction is not limited to the above examples. The selection may be appropriately made, for example, according to a user's intention such as a user's designation given after display of an image based on concatenated volume data as described later.

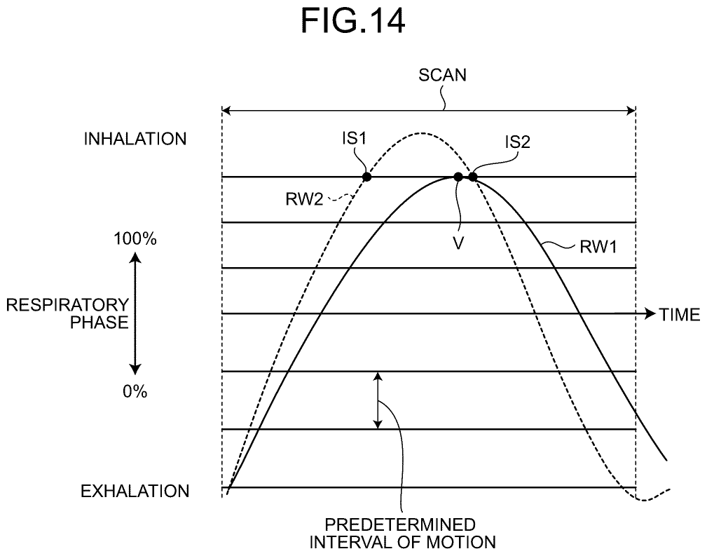

When at the different threshold-exceeding amplitudes, the first respiratory waveform and the second respiratory waveform are asynchronous with each other (hereinafter, referred to as Case B), the processing circuitry 117 uses the extracting function 135 to perform the depth-prioritized extraction. FIG. 14 illustrates an example of the first respiratory waveform RW1 and the second respiratory waveform RW2 in Case B. As illustrated in FIG. 14, in Case B the upper and lower lungs are scanned at different depths exceeding a preset depth and out of phase along the time axis. FIG. 14 shows an exemplary depth-prioritized extraction. In FIG. 14 the first respiratory waveform RW1 is the respiratory waveform (indicated by the solid line) having a smaller maximum respiratory phase. The horizontal lines in the graph of FIG. 14 represent predetermined intervals of motion based on the maximum respiratory phase of the first respiratory waveform RW1, i.e., a time phase corresponding to the peak of the solid-line respiratory waveform. The extracting function 135 identifies multiple time phases at multiple intersections between the first respiratory waveform RW1 and the horizontal lines (values of respiratory positions) except for the peak V of the first respiratory waveform RW1. In each of the time phases, the extracting function 135 then extracts projection data included in the angular range around the angle corresponding to each of the time phases as the first projection dataset.

FIG. 14 differs from FIG. 12 in that, regarding the two intersections (IS1, IS2) between the same respiratory phase (horizontal line) as the peak V of the first respiratory waveform RW1 and the second respiratory waveform RW2, the second intersection IS2 is closer to the peak V of the first respiratory waveform RW1 than the first intersection IS1. Because of this, the second projection dataset corresponding to the peak V to be extracted can be, for example, projection data included in the angular range around the angle corresponding to the time phase of the second intersection IS2. The extraction process with respect to the second projection dataset may conform to the process explained referring to FIG. 12.

In the time-prioritized extraction in Case B, the processing circuitry 117 uses the extracting function 135 to extract first projection datasets from the first projection data at reconstuctible time phase intervals, and extract second projection datasets from the second projection data at the same reconstuctible time phase intervals. As illustrated in FIG. 14, the cycle of the first respiratory waveform RW1 is longer than that of the second respiratory waveform RW2. For example, assumed that performing a first scan in synchronization with the first respiratory waveform RW1 takes 20 seconds while performing a second scan in synchronization with the second respiratory waveform RW2 takes 10 seconds, and volume data is reconstructed at reconstuctible time phase intervals of one second. In this case, 20 pieces of volume data are reconstructed from the first projection datasets and 10 pieces of volume data are reconstructed from the second projection datasets. In this regard, the image processing function 139 performs interpolation of the volume data, which will be described later.

The processing circuitry 117 uses the reconstruction function 137 to reconstruct first volume data based on the first projection datasets and reconstruct second volume data based on the second projection datasets. For example, as illustrated in FIG. 10 and FIG. 13, the reconstruction function 137 reconstructs first volume data from the first projection dataset and second volume data from the second projection dataset in each of the time phases represented by the vertical lines. Specifically, when the first projection dataset has been extracted in each of the time phases by the time-prioritized extraction, the reconstruction function 137 individually reconstructs a plurality of pieces of first volume data corresponding to the time phases based on the first projection datasets corresponding to the same time phases. Similarly, when the second projection dataset has been extracted in each of the time phases by the time-prioritized extraction, the reconstruction function 137 individually reconstructs a plurality of pieces of second volume data corresponding to the time phases based on the second projection datasets corresponding to the same time phases.

When in the depth-prioritized extraction, the first respiratory waveform and the second respiratory waveform are asynchronous with each other at the same threshold-exceeding amplitude, the processing circuitry 117 uses the reconstruction function 137 to reconstruct first volume data based on the first projection datasets and second volume data based on the second projection datasets at different depths (multiple amplitudes in the respiratory waveform). As illustrated in FIG. 11, FIG. 12, and FIG. 14, for example, the reconstruction function 137 reconstructs the first volume data from the first projection dataset and the second volume data from the second projection dataset in each of the time phases corresponding to the respiratory phases indicated by the horizontal lines.

Specifically, when the first projection dataset has been extracted in each of the respiratory phases by the depth-prioritized extraction, the reconstruction function 137 individually reconstructs a plurality of pieces of first volume data corresponding to the respiratory phases based on the first projection datasets corresponding to the respiratory phases. Similarly, when the second projection dataset has been extracted in each of the respiratory phases by the depth-prioritized extraction, the reconstruction function 137 individually reconstructs a plurality of pieces of second volume data corresponding to the respiratory phases based on the second projection datasets corresponding to the respiratory phases.

The processing circuitry 117 uses the reconstruction function 137 to store the reconstructed first volume data and second volume data in the memory 112, in association with each of the time phases. That is, the plurality of pieces of first volume data and the plurality of pieces of second volume data are stored in a time series in the memory 112, in association with the respective time phases or respiratory phases in the respiratory waveform. The processing circuitry 117 implementing the reconstruction function 137 corresponds to a reconstruction unit.

The processing circuitry 117 uses the image processing function 139 to generate concatenated volume data as to the imaging region by concatenating the first volume data and the second volume data in the multiple time phases or respiratory phases. For example, when the first projection dataset has been extracted in each of the time phases by the time-prioritized extraction, the image processing function 139 generates concatenated volume data by concatenating the first volume data and the second volume data in each of the time phases. When the first projection dataset has been extracted in each of the respiratory phases by the depth-prioritized extraction, the image processing function 139 generates concatenated volume data by concatenating the first volume data and the second volume data in the respiratory phases, i.e., at different depths. The concatenation of the first volume data and the second volume data can be suitably implemented by, for example, a known registration process, therefore, a description thereof is omitted.

In the time-prioritized extraction in Case B, the processing circuitry 117 uses the image processing function 139 to perform interpolation of volume data prior to the volume-data concatenation. For example, the image processing function 139 interpolates multiple pieces of volume data based on one of the first dynamic data and the second dynamic data, the one representing the subject P moving in a shorter cycle. In this manner, the image processing function 139 generates interpolated volume data in two or more time phases corresponding to multiple pieces of volume data based on the other of the first dynamic data and the second dynamic data representing the subject P moving in a longer cycle.

Specifically, as illustrated in FIG. 14, assumed that performing a first scan in synchronization with the first respiratory waveform RW1 takes 20 seconds and performing a second scan in synchronization with the second respiratory waveform RW1 takes 10 seconds, and volume data is reconstruct at reconstructible time phase intervals of one second. In this case, 20 pieces of first volume data are reconstructed while 10 pieces of second volume data are reconstructed. Thus, the image processing function 139 of the processing circuitry 117 generates interpolated volume data of the second volume data having a shorter cycle by interpolating the time phase between two temporally adjacent sets of second volume data. This makes it possible to associate the first volume data and another volume data having the same time phase by using the second volume data and the interpolated volume data. Any of known image interpolation methods such as linear interpolation is applicable to this interpolation process, therefore, a description thereof is omitted.

Next, the processing circuitry 117 uses the image processing function 139 to generate concatenated volume data based on the first volume data, the second volume data, and the interpolated volume data. According to the example above, concatenated volume data is generated by concatenating the first volume data and the second volume data or the interpolated volume data in each of the time phases. The image processing function 139 generates concatenated volume data through such a process.

The processing circuitry 117 further uses the image processing function 139 to perform three-dimensional image processing, including volume rendering, surface volume rendering, intensity projection, multi-planer reconstruction (MPR), or curved MPR (CPR), to the concatenated volume data to generate display images. For example, the image processing function 139 subjects the concatenated volume data to a multi-planer reconstruction (MPR) process to generate sagittal images, coronal images, axial images, and/or oblique images of the imaging region concerned.

The image processing to the concatenated volume data is not limited to the above examples, and any of various kinds of known image processing may be applied. In addition, an object to undergo the image processing may be any of various kinds of two-dimensional images and/or another type of volume data, in addition to the concatenated volume data. The image processing function 139 stores the resultant concatenated volume data and various types of images generated through the image processing to the concatenated volume data in the memory 112. The various types of images resulting from the image processing to the concatenated volume data are also displayed on the display 116. The processing circuitry 117 implementing the image processing function 139 corresponds to an image processing unit.

The processing circuitry 117 uses the notifying function 141 to notify the user of various kinds of information. In the following, the first scan for acquiring the first projection data on the first region is defined to be performed prior to the second scan for acquiring the second projection data on the second region for the sake of specificity. For example, upon determination that the magnitude of motion (respiratory phase) of the subject P represented in the first dynamic data (first respiratory waveform) matches or is less than the threshold, the notifying function 141 notifies the user of re-execution of the first scan (hereinafter, called a first re-scan notification). Upon determination that the magnitude of motion (respiratory phase) of the subject P represented in the first dynamic data (first respiratory waveform) exceeds the threshold and the magnitude of motion of the subject P represented in the second dynamic data (second respiratory waveform) matches or is less than the threshold, the notifying function 141 notifies the user of re-execution of the second scan (hereinafter, called a second re-scan notification).

To notify the user via audio, the notifying function 141 causes a speaker to output audio representing a re-scan notification. To notify the user using an image, the notifying function 141 causes the display 116 to display an image depicting a re-scan notification. The processing circuitry 117 implementing the notifying function 141 corresponds to a notifying unit.

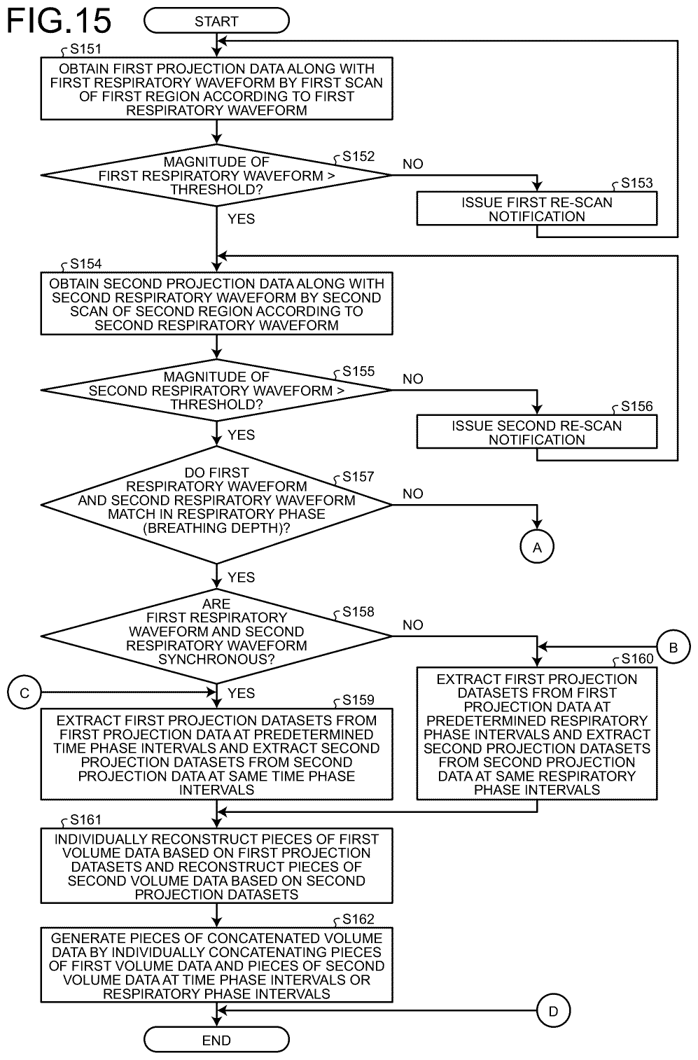

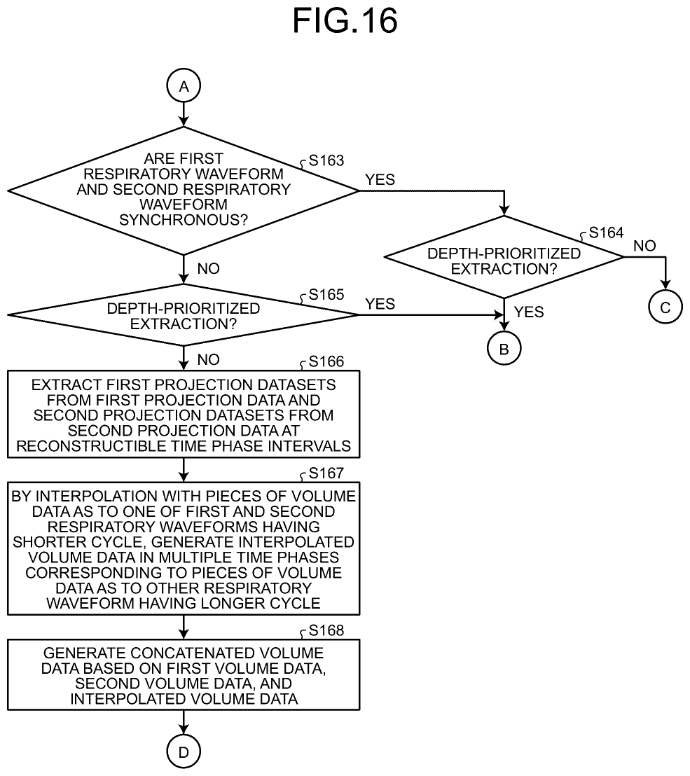

The overall structure and configuration of the X-ray CT apparatus 1 have been explained above. The following will describe a process of generating concatenated volume data (hereinafter, concatenated-data generation process). FIG. 15 and FIG. 16 are flowcharts illustrating steps of the concatenated-data generation process by way of example.

### Concatenated-Data Generation Process

### Step S151

The host controller 110 performs a first scan of the first region in accordance with the first respiratory waveform. The preprocessing apparatus 106 generates first projection data resulting from the first scan. In this manner, the obtaining function 131 of the processing circuitry 117 obtains the first projection data along with the first respiratory waveform. The obtaining function 131 stores the first projection data and the first respiratory waveform in the memory 112 in association with each other.

### Step S152

The processing circuitry 117 uses the determining function 133 to determine whether or not the magnitude of the first respiratory waveform, i.e., the maximum amplitude of the first respiratory waveform, exceeds a threshold. When the magnitude of the first respiratory waveform exceeds the threshold (YES at step S152), the process proceeds to step S154. When the magnitude of the first respiratory waveform does not exceed the threshold (NO at step S152), the process proceeds to step S153.

### Step S153

The processing circuitry 117 uses the notifying function 141 to issue the first re-scan notification to the user for recommending performing the first scan again. In response to an input of a user instruction for performing the first scan again via the input unit 115, the operation at step S151 is performed again. The first re-scan notification is issued, for example, at the time when the breathing depth of the subject P matches or is below the threshold.

### Step S154

The host controller 110 performs a second scan of the second region in accordance with the second respiratory waveform. The preprocessing apparatus 106 generates second projection data resulting from the second scan. In this manner, the obtaining function 131 of the processing circuitry 117 obtains the second projection data together with the second respiratory waveform. The obtaining function 131 stores the second projection data and the second respiratory waveform in the memory 112 in association with each other.

### Step S155

The processing circuitry 117 uses the determining function 133 to determine whether or not the magnitude of the second respiratory waveform, i.e., the maximum amplitude of the second respiratory waveform, exceeds the threshold. When the magnitude of the second respiratory waveform exceeds the threshold (YES at step S155), the process proceeds to step S157. When the magnitude of the second respiratory waveform does not exceed the threshold (NO at step S155), the process proceeds to step S156.

### Step S156

The processing circuitry 117 uses the notifying function 141 to issue the second re-scan notification to the user for recommending performing the second scan again. In response to an input of a user instruction for performing the second scan again via the input unit 115, the operation at step S154 is performed again. The second re-scan notification is issued, for example, at the time when the breathing depth of the subject P matches or is below the threshold.

### Step S157

The processing circuitry 117 uses the determining function 133 to determine whether or not the first respiratory waveform and the second respiratory waveform match each other in terms of the respiratory phase (breathing depth or the maximum amplitude value of the respiratory waveform). When the first respiratory waveform and the second respiratory waveform match each other in breathing depth (YES at step S157), the process proceeds to step S158. When the first respiratory waveform and the second respiratory waveform differ in breathing depth (NO at step S157), the process proceeds to step S163.

### Step S158

The processing circuitry 117 further uses the determining function 133 to determine whether or not the first respiratory waveform and the second respiratory waveform are synchronized with each other. When the first respiratory waveform and the second respiratory waveform are synchronized with each other (YES at step S158), the process proceeds to step S159. When the first respiratory waveform and the second respiratory waveform are not synchronized with each other (NO at step S158), the process proceeds to step S160.

### Step S159

The processing circuitry 117 uses the extracting function 135 to extract a plurality of first projection datasets from the first projection data at predetermined time phase intervals. Further, the extracting function 135 extracts a plurality of second projection datasets from the second projection data at the same predetermined time phase intervals. The extracting function 135 stores the plurality of first projection datasets and the plurality of second projection datasets in the memory 112.

### Step S160

The processing circuitry 117 further uses the extracting function 135 to extract a plurality of first projection datasets from the first projection data at predetermined respiratory phase (breathing depth) intervals. In addition the extracting function 135 extracts a plurality of second projection datasets from the second projection data at the same predetermined respiratory phase intervals. The extracting function 135 stores the plurality of first projection datasets and the plurality of second projection datasets in the memory 112.

### Step S161

The processing circuitry 117 uses the reconstruction function 137 to individually reconstruct a plurality of pieces of first volume data based on the plurality of first projection datasets. Also, the reconstruction function 137 individually reconstructs a plurality of pieces of second volume data based on the plurality of second projection datasets. The reconstruction function 137 stores the plurality of pieces of first volume data and the plurality of pieces of second volume data in the memory 112.

### Step S162

The processing circuitry 117 uses the image processing function 139 to generate a plurality of pieces of concatenated volume data by individually concatenating the plurality of pieces of first volume data and the plurality of pieces of second volume data at the time phase intervals or the respiratory phase intervals. For example, when the first projection datasets and the second projection datasets have been extracted at the time phase intervals of the respiratory waveform, the image processing function 139 generates concatenated volume data by concatenating the first volume data and the second volume data at the time phase intervals. When the first projection datasets and the second projection datasets have been extracted at the respiratory phase intervals, the image processing function 139 generates concatenated volume data by concatenating the first volume data and the second volume data at the respiratory phase intervals. The image processing function 139 stores the resultant pieces of concatenated volume data in the memory 112.

### Step S163

The processing circuitry 117 uses the determining function 133 to determine whether or not the first respiratory waveform and the second respiratory waveform are synchronized with each other. When the first respiratory waveform and the second respiratory waveform are synchronized with each other (YES at step S163), the process proceeds to step S164. When the first respiratory waveform and the second respiratory waveform are not synchronized with each other (NO at step S163), the process proceeds to step S165.

### Step S164

In response to a selection of the depth-prioritized extraction according to a user instruction given via the input unit 115 and/or the items of an examination order (YES at step S164), the operation at step S160 is performed. In response to no selection of the depth-prioritized extraction according to a user instruction given via the input unit 115 and/or the items of an examination order (NO at step S164), the operation at step S159 is performed.

### Step S165

In response to a selection of the depth-prioritized extraction according to a user instruction given via the input unit 115 and/or the items of an examination order (YES at step S165), the operation at step S160 is performed. In response to no selection of the depth-prioritized extraction according to a user instruction given via the input unit 115 and/or the items of an examination order (NO at step S165), the operation at step S166 is performed.

### Step S166

The processing circuitry 117 uses the extracting function 135 to extract a plurality of first projection datasets from the first projection data at reconstructible time phase intervals. Similarly, the extracting function 135 extracts a plurality of second projection datasets from the second projection data at reconstructible time phase intervals. The extracting function 135 stores the plurality of first projection datasets and the plurality of second projection datasets in the memory 112.

### Step S167

The processing circuitry 117 uses the image processing function 139 to perform an interpolation process to the pieces of volume data as to one of the first respiratory waveform and the second respiratory waveform, the one having a shorter cycle. Through the interpolation process, the image processing function 139 generates interpolated volume data in multiple time phases corresponding to the pieces of volume data as to the other of the first respiratory waveform and the second respiratory waveform having a longer cycle. The image processing function 139 stores the interpolated volume data in the memory 112.

### Step S168

The processing circuitry 117 further uses the image processing function 139 to generate concatenated volume data based on the first volume data, the second volume data, and the interpolated volume data. The image processing function 139 stores the concatenated volume data in the memory 112. This completes the concatenated-data generation process.

According to some embodiments as above, the medical image processing apparatus 40 obtains first projection data as to a first region of an imaging region of the subject P together with first dynamic data representing motion of the subject P, and obtains second projection data as to a second region of the imaging region together with second dynamic data representing the motion of the subject P. The second region is different from the first region. When the first dynamic data and the second dynamic data both exceed a threshold and the first dynamic data and the second dynamic data match each other in magnitude of the motion of the subject P, the medical image processing apparatus 40 extracts, from the first projection data, a first projection dataset corresponding to an angular range suited for image reconstruction based on the first dynamic data at a predetermined time phase interval or according to the magnitude of the motion, and extracts, from the second projection data, a second projection dataset corresponding to the angular range based on the second dynamic data at the same predetermined time phase interval or the second projection dataset as to the same magnitude of the motion as the first projection dataset. When the first dynamic data and the second dynamic data both exceed the threshold and differ in the magnitude of the motion from each other, the medical image processing apparatus 40 extracts the first projection dataset from the first projection data according to the magnitude of the motion in the first dynamic data, and extracts, from the second projection data, the second projection dataset as to the same magnitude of motion as the first projection dataset, based on the second dynamic data. The medical image processing apparatus 40 then reconstructs first volume data based on the first projection dataset and reconstructs second volume data based on the second projection dataset, and generates concatenated volume data as to the imaging region of the subject P by concatenating the first volume data and the second volume data.

When the first dynamic data and the second dynamic data both exceed the threshold, the first dynamic data and the second dynamic data match each other in the magnitude of the motion of the subject P, and the motion in the first dynamic data and the motion in the second dynamic data are synchronous with each other, the medical image processing apparatus 40 according to one embodiment extracts the first projection dataset from the first projection data based on the first dynamic data at the predetermined time phase interval, and extracts the second projection dataset from the second projection data based on the second dynamic data at the same predetermined time phase interval. When the first dynamic data and the second dynamic data both exceed the threshold, the first dynamic data and the second dynamic data differ from each other in the magnitude of the motion of the subject P, and the motion in the first dynamic data and the motion in the second dynamic data are asynchronous with each other, the medical image processing apparatus 40 according to one embodiment extracts the first projection dataset from the first projection data at a predetermined interval of motion, and extracts, from the second projection data, the second projection dataset as to the same motion as in the first projection dataset based on the second dynamic data.

Further, when the first dynamic data and the second dynamic data both exceed the threshold, the first dynamic data and the second dynamic data differ from each other in the magnitude of the motion of the subject P, and the motion in the first dynamic data and the motion in the second dynamic data are synchronous with each other, the medical image processing apparatus 40 according to one embodiment extracts the first projection dataset from the first projection data at the predetermined time phase interval and extracts the second projection dataset from the second projection data based on the second dynamic data at the same predetermined time phase interval.

Owing to the features as above, at the same threshold-exceeding amplitude, the medical image processing apparatus 40 of one embodiment can reconstruct the first volume data and the second volume data based on the first projection dataset and the second projection dataset both of which have been extracted in the same time phase and at the same time phase interval (time-prioritized extraction) relative to the subject P's motion, to be able to generate concatenated volume data by concatenating the first volume data and the second volume data. Further, at the different threshold-exceeding amplitudes, the medical image processing apparatus 40 of one embodiment can reconstruct the first volume data and the second volume data based on the first projection dataset and the second projection dataset both of which have been extracted at the same magnitude of the subject P's motion (depth-prioritized extraction), to be able to generate concatenated volume data by concatenating the first volume data and the second volume data.

As such, the medical image processing apparatus 40 of one embodiment can generate dynamic images of an intended object in the subject P across a larger region, in the imaging region including multiple regions, suitable for diagnosis of the subject P irrespective of the magnitude of the subject P's motion.

Further, when the first dynamic data and the second dynamic data both exceed the threshold, the first dynamic data and the second dynamic data differ from each other in the magnitude of the motion of the subject P, and the motion in the first dynamic data and the motion in the second dynamic data are asynchronous with each other, the medical image processing apparatus 40 of one embodiment extracts the first projection dataset from the first projection data at a reconstructible time phase interval, and extracts the second projection dataset from the second projection data at the reconstructible time phase interval. The medical image processing apparatus 40 then generates, by interpolation with a plurality of pieces of volume data related to one of the first dynamic data and the second dynamic data, the one representing the motion of the subject in a shorter cycle, interpolated volume data at multiple time phases corresponding to a plurality of pieces of volume data related to the other of the first dynamic data and the second dynamic data representing the motion of the subject P in a longer cycle, and generates concatenated volume data based on the first volume data, the second volume data, and the interpolated volume data.

Thus, in Case B where at the different threshold-exceeding amplitudes, the first respiratory waveform and the second respiratory waveform are asynchronous with each other, after the time-prioritized extraction, the medical image processing apparatus 40 of one embodiment can generate interpolated volume data through the interpolation process using the pieces of volume data related to dynamic data representing the subject P moving in a shorter cycle, to generate concatenated volume data based on the first volume data, the second volume data, and the interpolated volume data. In this manner the medical image processing apparatus 40 according to one embodiment can generate dynamic images of an intended object in the subject P across a larger region, in the imaging region including multiple regions, suitable for diagnosis of the subject P, irrespective of difference in cycle between the first dynamic data and the second dynamic data.

As such, the medical image processing apparatus 40 of one embodiment can generate dynamic images of an intended object in the subject P across a larger region, in the imaging region including multiple regions, suitable for diagnosis of the subject P, irrespective of the magnitude and cycle of the motion of the subject P. For example, in the respiration-synchronous dynamic scan of the upper and lower lungs of the subject P, the medical image processing apparatus 40 of one embodiment can generate dynamic images representing the upper and lower lungs with no differences in motion even if the subject P's breathing varies along the time axis or varies in depth.

Further, the medical image processing apparatus 40 according to one embodiment generates the first projection data by the first scan of the first region and the second projection data by the second scan of the second region. The first scan is conducted prior to the second scan. The medical image processing apparatus 40 of one embodiment determines whether the magnitude of motion of the subject P in the first dynamic data exceeds the threshold and whether the magnitude of motion of the subject P in the second dynamic data is equal to or less than the threshold. When determining that the magnitude of motion of the subject P in the first dynamic data exceeds the threshold and that the magnitude of motion of the subject P in the second dynamic data is equal to or less than the threshold, the medical image processing apparatus 40 informs the user of re-execution of the second scan.

The medical image processing apparatus 40 according to one embodiment generates the first projection data by the first scan of the first region and the second projection data by the second scan of the second region. The first scan is conducted prior to the second scan. The medical image processing apparatus 40 of one embodiment determines whether the magnitude of motion of the subject P in the first dynamic data exceeds the threshold. When determining that the magnitude of motion of the subject P in the first dynamic data is equal to or less than the threshold, the medical image processing apparatus 40 informs the user of re-execution of the first scan.

As such, the medical image processing apparatus 40 of one embodiment can recommend the user to perform again the scan by which the projection data corresponding to the maximum value, matching or being less than the threshold, of either of the first dynamic data and the second dynamic data, has been acquired. Thus, the medical image processing apparatus 40 of one embodiment allows the user to readily know the necessity for re-scanning, thereby improving efficiency in generation of images of a larger area suitable for diagnosing.

### First Modification

A first modification involves use of a size of an object to be imaged for determination as to the first re-scan notification and the second re-scan notification. According to the first modification, the process related to the concatenated-data generation process is performed, for example, following step S161 and step S166.

The processing circuitry 117 uses the image processing function 139 to calculate a size of an object to be imaged in the first volume data (hereinafter, a first size). When the object to be imaged is the lungs of the subject P and the first region corresponds to the upper lung, for example, the first size corresponds to the size of the upper lung. The calculation of the upper lung size in the first volume data can be implemented by, for example, any of known image processing methods such as segmentation or image recognition of the upper lung in the first volume data, therefore, a description thereof is omitted.

The processing circuitry 117 further uses the image processing function 139 to calculate a size of an object to be imaged in the second volume data (hereinafter, a second size). When the object to be imaged is the lungs of the subject P and the second region corresponds to the lower lung, for example, the second size corresponds to the size of the lower lung. The calculation of the lower lung size in the second volume data can be implemented by, for example, any of known image processing methods such as segmentation or image recognition of the lower lung in the second volume data, therefore, a description thereof is omitted.

The processing circuitry 117 then uses the determining function 133 to determine whether or not the first size is equal to or less than a predetermined size. The determining function 133 also determines whether or not the first size exceeds the predetermined size and the second size is equal to or less than the predetermined size. The predetermined size is pre-stored in the memory 112.

When the first size is equal to or less than the predetermined size, the processing circuitry 117 uses the notifying function 141 to notify the user of re-execution of the first scan, i.e., issues the first re-scan notification to the user. When the first size exceeds the predetermined size and the second size is equal to or less than the predetermined size, the notifying function 141 notifies the user of re-execution of the second scan, i.e., gives the user the second re-scan notification. The rest of the processing in the first modification conforms to the processing in some embodiments, therefore, a description thereof is omitted.

The medical image processing apparatus 40 according to the first modification of the above embodiments generates the first projection data of the first region by the first scan and generates the second projection data of the second region by the second scan. The first scan is performed prior to the second scan. The medical image processing apparatus 40 according to the first modification calculates a first size of an object to be imaged in the first volume data, calculates a second size of the object to be imaged in the second volume data, determines whether or not the first size exceeds a predetermined size and the second size is equal to or less than the predetermined size, and notifies the user of re-execution of the second scan when the first size exceeds the predetermined size and the second size is equal to or less than the predetermined size.

Further, the medical image processing apparatus 40 according to the first modification generates the first projection data of the first region by the first scan and generates the second projection data of the second region by the second scan. The first scan is performed prior to the second scan. The medical image processing apparatus 40 according to the first modification calculates a first size of an object to be imaged in the first volume data, determines whether or not the first size is equal to or less than the predetermined size, and notifies the user of re-execution of the first scan when the first size is equal to or less than the predetermined size.

The medical image processing apparatus 40 according to the first modification is able to notify the user of the necessity for re-scanning depending on the size of the object to be imaged in the reconstructed volume data by the reconstruction function 137. In this manner the medical image processing apparatus 40 according to the first modification allows the user to readily know the necessity for re-scanning, thereby improving the efficiency in generation of images of a larger area suitable for diagnosing. The rest of the effects are similar to or the same as those of some embodiments, therefore, a description thereof is omitted.

### Second Modification

A second modification involves providing the user with at least one of the first re-scan notification and the second re-scan notification according to a result of determination on whether a difference between the maximum values of the motion of the subject P in the first dynamic data and in the second dynamic data exceeds a predetermined value. According to the second modification, the process related to the concatenated-data generation process is performed, for example, following step S161 and step S166.

The processing circuitry 117 uses the determining function 133 to determine whether a difference between the maximum values of motion of the subject P in the first dynamic data and in the second dynamic data exceeds a predetermined value. The predetermined value is pre-stored in the memory 112. For example, the determining function 133 may determine whether a difference between the maximum value of motion (maximum respiratory phase/amplitude) of the upper lung in the first respiratory waveform and the maximum value of motion (maximum respiratory phase/amplitude) of the lower lung in the second respiratory waveform exceeds a predetermined value. The difference corresponds to a difference in breathing depth.

When the difference exceeds the predetermined value, the processing circuitry 117 uses the notifying function 141 to notify the user of re-execution of at least one of the first scan and the second scan, i.e., give the user at least one of the first re-scan notification and the second re-scan notification. The rest of the processing in the second modification conforms to the processing in some embodiments, therefore, a description thereof is omitted.

According to the second modification of some embodiments, the medical image processing apparatus 40 determines whether the difference between the maximum value of motion of the subject P in the first dynamic data (hereinafter, a first maximum value) and the maximum value of motion of the subject P in the second dynamic data (hereinafter, a second maximum value) exceeds the predetermined value. When the difference is larger than the predetermined value, the medical image processing apparatus 40 notifies the user of re-execution of at least either of the first scan and the second scan.

The medical image processing apparatus 40 according to the second modification can recommend the user to perform scanning again if the difference between the first maximum value and the second maximum value, that is, the difference in the ranges of the magnitudes of motion between in the first dynamic data and in the second dynamic data, is larger than the predetermined value. Thereby, the medical image processing apparatus 40 according to the second modification enables the user to readily select a re-scan, leading to improving the efficiency in generation of images of a larger area suitable for diagnosis. The rest of the effects is similar to or the same as those of some embodiments, therefore, a description thereof is omitted.

To implement the technical ideas of the present embodiment by a medical image processing method, the medical image processing method includes obtaining first projection data as to a first region of an imaging region of a subject P together with first dynamic data representing motion of the subject P; obtaining second projection data as to a second region of the imaging region together with second dynamic data representing the motion of the subject P, the second region being different from the first region; when the first dynamic data and the second dynamic data both exceed a threshold and the first dynamic data and the second dynamic data match each other in magnitude of the motion, extracting, from the first projection data, a first projection dataset corresponding to an angular range suited for image reconstruction based on the first dynamic data at a predetermined time phase interval, and extracting, from the second projection data, a second projection dataset corresponding to the angular range based on the second dynamic data at the predetermined time phase interval; when the first dynamic data and the second dynamic data both exceed the threshold and the first dynamic data and the second dynamic data differ from each other in the magnitude of the motion, extracting the first projection dataset from the first projection data according to the magnitude of the motion in the first dynamic data, and extracting, from the second projection data, the second projection dataset as to the same magnitude of the motion as the first projection dataset, based on the second dynamic data; reconstructing first volume data based on the first projection dataset; reconstructing second volume data based on the second projection dataset; and generating concatenated volume data as to the imaging region of the subject P by concatenating the first volume data and the second volume data. The procedure and effects of the medical image processing method are similar to or the same as those of some embodiments, therefore, a description thereof is omitted.

To implement the technical ideas of the present embodiment by a medical image processing program, the medical image processing program causes the computer to perform obtaining first projection data as to a first region of an imaging region of a subject P together with first dynamic data representing motion of the subject P; obtaining second projection data as to a second region of the imaging region together with second dynamic data representing the motion of the subject P, the second region being different from the first region; when the first dynamic data and the second dynamic data both exceed a threshold and the first dynamic data and the second dynamic data match each other in magnitude of the motion, extracting, from the first projection data, a first projection dataset corresponding to an angular range suited for image reconstruction based on the first dynamic data at a predetermined time phase interval and extract, from the second projection data, a second projection dataset corresponding to the angular range based on the second dynamic data at the predetermined time phase interval; when the first dynamic data and the second dynamic data both exceed the threshold and the first dynamic data and the second dynamic data differ from each other in the magnitude of the motion, extracting the first projection dataset from the first projection data according to the magnitude of the motion in the first dynamic data, and extracting, from the second projection data, the second projection dataset as to the same magnitude of the motion as the first projection dataset, based on the second dynamic data; reconstructing first volume data based on the first projection dataset; reconstructing second volume data based on the second projection dataset; and generating concatenated volume data as to the imaging region of the subject P by concatenating the first volume data and the second volume data.

In this case, the program for causing the computer to execute such a method can be stored and distributed in a storage medium such as a magnetic disk (e.g., hard disk), an optical disk (e.g., CD-ROM, DVD), or a semiconductor memory. The procedure and effects of the medical image processing program are similar to or the same as those of some embodiments, therefore, a description thereof is omitted herein.

According to at least one of the embodiments and modifications described above, for example, it is possible to generate images of a larger area suitable for diagnosing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A medical image processing apparatus comprising processing circuitry configured to:
obtain first projection data as to a first region of an imaging region of a subject together with first dynamic data representing motion of the subject;
obtain second projection data as to a second region of the imaging region together with second dynamic data representing the motion of the subject, the second region being different from the first region;
when the first dynamic data and the second dynamic data both exceed a threshold and the first dynamic data and the second dynamic data match each other in magnitude of the motion of the subject,
extract, from the first projection data, a first projection dataset corresponding to an angular range suited for image reconstruction at a predetermined time phase interval or according to the magnitude of the motion, and
extract, from the second projection data, a second projection dataset corresponding to the angular range at the predetermined time phase interval or the second projection dataset as to a same magnitude of the motion as the first projection dataset;
when the first dynamic data and the second dynamic data both exceed the threshold and the first dynamic data and the second dynamic data differ from each other in the magnitude of the motion of the subject,
extract the first projection dataset from the first projection data according to the magnitude of the motion, and
extract the second projection dataset as to the same magnitude of the motion as the first projection data from the second projection data;
reconstruct first volume data based on the first projection dataset and reconstruct second volume data based on the second projection dataset; and
generate concatenated volume data as to the imaging region of the subject by concatenating the first volume data and the second volume data.

2. The medical image processing apparatus according to claim 1, wherein
when the first dynamic data and the second dynamic data both exceed the threshold, the first dynamic data and the second dynamic data match each other in the magnitude of the motion of the subject, and the motion in the first dynamic data and the motion in the second dynamic data are synchronous with each other,
the processing circuitry is configured to
extract the first projection dataset from the first projection data based on the first dynamic data at the predetermined time phase interval, and
extract the second projection dataset from the second projection data based on the second dynamic data at the predetermined time phase interval; and
when the first dynamic data and the second dynamic data both exceed the threshold, the first dynamic data and the second dynamic data differ from each other in the magnitude of the motion of the subject, and the motion in the first dynamic data and the motion in the second dynamic data are asynchronous with each other,
the processing circuitry is configured to
extract the first projection dataset from the first projection data at a predetermined interval of the motion, and
extract, from the second projection data, the second projection dataset as to same motion as the first projection dataset, based on the second dynamic data.

3. The medical image processing apparatus according to claim 1, wherein
when the first dynamic data and the second dynamic data both exceed the threshold, the first dynamic data and the second dynamic data differ from each other in the magnitude of the motion of the subject, and the motion in the first dynamic data and the motion in the second dynamic data are synchronous with each other, the processing circuitry is configured to:
extract the first projection dataset from the first projection data at the predetermined time phase interval, and
extract the second projection dataset from the second projection data at the predetermined time phase interval based on the second dynamic data.

4. The medical image processing apparatus according to claim 1, wherein
when the first dynamic data and the second dynamic data both exceed the threshold, the first dynamic data and the second dynamic data differ from each other in the magnitude of the motion of the subject, and the motion in the first dynamic data and the motion in the second dynamic data are asynchronous with each other, the processing circuitry is configured to:
extract the first projection dataset from the first projection data at a reconstructible time phase interval based on the first dynamic data, and extract the second projection dataset from the second projection data at the reconstructible time phase interval based on the second dynamic data,
generate, by interpolation with a plurality of pieces of volume data related to one of the first dynamic data and the second dynamic data, the one representing the motion having a shorter cycle, interpolated volume data in a plurality of time phases corresponding to a plurality of pieces of volume data related to the other of the first dynamic data and the second dynamic data representing the motion having a longer cycle, and
generate the concatenated volume data based on the first volume data, the second volume data, and the interpolated volume data.

5. The medical image processing apparatus according to claim 1, wherein
the first projection data is generated by a first scan of the first region,
the second projection data is generated by a second scan of the second region,
the first scan is performed prior to the second scan, and
the processing circuitry is configured to notify a user of re-execution of the second scan when the magnitude of the motion in the first dynamic data exceeds the threshold and the magnitude of the motion in the second dynamic data is equal to or less than the threshold.

6. The medical image processing apparatus according to claim 1, wherein
the first projection data is generated by a first scan of the first region,
the second projection data is generated by a second scan of the second region,
the first scan is performed prior to the second scan, and
the processing circuitry is configured to:
calculate a first size of an object to be imaged in the first volume data,
calculate a second size of the object to be imaged in the second volume data, and
notify a user of re-execution of the second scan when the first size exceeds a predetermined size and the second size is equal to or less than the predetermined size.

7. The medical image processing apparatus according to claim 1, wherein
the first projection data is generated by a first scan of the first region,
the second projection data is generated by a second scan of the second region,
the first scan is performed prior to the second scan, and
the processing circuitry is configured to notify a user of re-execution of the first scan when the magnitude of the motion in the first dynamic data is equal to or less than the threshold.

8. The medical image processing apparatus according to claim 1, wherein
the first projection data is generated by a first scan of the first region,
the second projection data is generated by a second scan of the second region,
the first scan is performed prior to the second scan, and
the processing circuitry is configured to:
calculate a first size of an object to be imaged in the first volume data, and
notify a user of re-execution of the first scan when the first size is equal to or less than a predetermined size.

9. The medical image processing apparatus according to claim 5, wherein
when a difference in maximum values of the magnitudes of the motion in the first dynamic data and in the second dynamic data exceeds a predetermined value, the processing circuitry is configured to notify the user of re-execution of at least either the first scan or the second scan.

10. A medical image processing method comprising:
obtaining first projection data as to a first region of an imaging region of a subject together with first dynamic data representing motion of the subject;
obtaining second projection data as to a second region of the imaging region together with second dynamic data representing the motion of the subject, the second region being different from the first region;
when the first dynamic data and the second dynamic data both exceed a threshold and the first dynamic data and the second dynamic data match each other in magnitude of the motion of the subject,
extracting, from the first projection data, a first projection dataset corresponding to an angular range suited for image reconstruction based on the first dynamic data at a predetermined time phase interval, and
extracting, from the second projection data, a second projection dataset corresponding to the angular range based on the second dynamic data at the predetermined time phase interval;
when the first dynamic data and the second dynamic data both exceed the threshold and the first dynamic data and the second dynamic data differ from each other in the magnitude of the motion of the subject,
extracting the first projection dataset from the first projection data according to the magnitude of the motion in the first dynamic data, and
extracting, from the second projection data, the second projection dataset as to same magnitude of the motion as the first projection dataset, based on the second dynamic data;
reconstructing first volume data based on the first projection dataset,
reconstructing second volume data based on the second projection dataset; and
generating concatenated volume data as to the imaging region of the subject by concatenating the first volume data and the second volume data.
